(19) United States
(12) Patent Application Publication
(10) Pub. No.: US 2012/0047797 A1
(43) Pub. Date: Mar. 1, 2012

(54) Device and Method for Production of Algae

(76) Inventors: Richard M. Berman, The Woodlands, TX (US); Larry Peyton, Montgomery, TX (US)

(21) Appl. No.: 12/871,551

(22) Filed: Aug. 30, 2010

(51) Int. Cl. A01G 1/00

(52) U.S. Cl. 47/1.4

(57) ABSTRACT

A scalable bioreactor and method of continuous production of algae in a controlled environment is disclosed.

### FIELD OF THE INVENTION

The invention concerns a device and method for reliable production of algae, utilizing a scalable bioreactor.

### BACKGROUND OF THE INVENTION

Renewable fuels, such as biodiesel, are of increasing interest, at least in part because there is an increasing concern regarding future shortages of fossil fuels. Environmental concerns also contribute to a desire to have reliable sources of clean burning, renewable fuels.

Much effort has been invested in using corn to produce such fuels, either biodiesel or ethanol. So long as the corn used for these products was surplus production, the effort to produce corn-based fuels did not generate significant economic effects. However, fuel production from corn has already reached a level that corn-based food products have seen price impacts from the competing demands on the corn supply.

Additionally, corn is a water intensive product. Approximately 4000 trillion gallons of water a year go into irrigation of the US corn crop. As the price of corn rises due to increased demand, farmers will be encouraged to abandon growing crops such as soybeans, that require less water than corn, and switch to corn production requiring still more water for irrigation.

Accordingly, it is highly desirable to provide an more efficient alternative source for biodiesel than corn. Certain strains of algae contain the proper oils for production of biodiesel, although no sufficiently efficient means of mass production of these algae yet exists in the marketplace. The lack of an efficient means to produce algae is especially important because algae are also widely used in the food industry (both for human and animal consumption), and also in pharmaceuticals, cosmetics, fertilizers, and other products.

Current production methods include open-pond methods, in which algae are grown in shallow flooded pits that are open to the environment. Such methods create substantial water losses due to evaporation. Yet, the National Renewable Energy Laboratory estimates that even these inefficient methods could produce enough algae for the production of sixty billion gallons per year of biodiesel at a water cost of no more than 120 trillion gallons per year. (“The Potential for Biofuels from Algae,” Philip Pienkos, Ph.D., Algae Biomass Summit, Nov. 15, 2007; see http://www.nrel.gov/docs/fy08osti/42414.pdf).

As mentioned above, open-pond production methods for algae are inefficient because they are subject to open evaporation. These methods also suffer because there is no control over other environmental factors, such as the availability of sunlight and temperature. Thus, this approach to algae production offers no ability to ensure even remotely optimal growing conditions.

As an alternative to open ponds, algae growers have sought to control the evaporation factor by laying serpentine lengths of transparent tubing in open fields and pumping a solution of algae and nutrients through the tubing. This method overcomes the evaporation problem, but remains subject to uncontrollable variations in temperature and sunlight. Additionally, required pumps add expense to such a system, and are subject to maintenance requirements. The tubing is also subject to rapid aging due to direct exposure to the ultraviolet components of sunlight, and represents an added expense when it must be replaced, both in the cost of the tubing and the downtime for the production plant.

Outdoor production facilities also suffer from an additional handicap, because they rely on sunlight to provide the light for the algae to photosynthesize, a process that must occur if the algae are to grow. Therefore, these facilities are essentially single-layer systems; they cannot be “stacked” because the upper levels would block sunlight from the lower ones. This factor means that outdoor production facilities are relegated to the old-style farming model, that is, production per acre can only be increased by increasing the efficiency of the growing process. As discussed above, there are severe limitations in these cases to improve the growing efficiency.

Other attempts have been made to bring the growing process indoors, and also to “stack” the flow path vertically, rather than laying it along the ground. For example, U.S. Pat. No. 7,536,827 (“the '827 patent”) discloses an indoor system of sluices that are racked vertically with a slight downslope to each sluice, so that a mixture of nutrient and algae may be propelled downward by gravity from the topmost (insertion) sluice, through each lower sluice in turn to the lowermost (harvest) sluice. Lighting under the bottom of each sluice may be used to provide light to the growing algae in the sluice below.

This system has several advantages over outdoor systems. The problem of sunlight variation has been effectively eliminated, and the indoor nature of the assemblage allows for environmental control of temperature and factors such as the CO₂ content of the atmosphere. Additionally, because the sluices are racked vertically, this system uses height as well as surface area for production, alleviating some of the inefficiency in land use of the outdoor systems. The gravity-feed system avoids the need for pumps to move the algae-nutrient mixture. Accordingly, the disclosure of the '827 patent represents an improvement over outdoor systems.

However, the device of the '827 patent retains certain inefficiencies. The necessarily large length required to grow the algae to sufficient size for harvesting, coupled with the necessary downslope for each sluice, requires a structure whose total height requires a custom building to house it. In fact, the '827 patent contemplates just such a structure. Moreover, the support assembly required to maintain the sluices in vertical alignment with each other represents a sizeable material cost, together with the contemplated pipage for such needs as warm-water heating if needed to maintain the desired temperature of the algae-nutrient mixture.

It is a goal of the invention to provide an economically sound device and method for growing algae under controlled conditions.

It is further another goal of the invention to provide a means for growing algae that is scalable.

It is yet another goal to provide a means for growing algae that does not require special structures to provide a contained environment.

### SUMMARY OF THE INVENTION

The invention is a bioreactor, and a method of operating said bioreactor, that provides a high yield of algae under controlled conditions. The bioreactor comprises a vessel, preferably sized so that it will fit inside an available building space, although a larger vessel requiring a customized containment facility would not depart from the spirit of the invention. A fluid mixture of water, nutrients, and algae is provided and fed into the upper zone of the vessel.

Because it is intended that the vessel will be used in a climate-controlled building, maintaining the proper temperature of the nutrient-algae mixture should not require the use of heating or cooling devices to control the liquid temperature.

Algae are photosynthetic, and require light to grow. To insure adequate light distribution throughout the vessel, a preferred embodiment of the bioreactor comprises one or more lamps depending on the size of the bioreactor vessel. In one embodiment of the invention, tubes of glass or another transparent material with one sealed end are inserted into the nutrient-algae mixture with their open end remaining in air. Fluorescent lights are inserted into the tubes to provide even lighting of the interior of the vessel. It is preferable to position the lamps with their longitudinal axes aligned substanstially with the long axis of the vessel. If more than one lamp is required due to the size of the vessel, it is preferable to space the lamps within the vessel to provide substantially uniform illumination throughout the vessel. As those of skill in the art will understand, the lamps may be frequency adjustable, or frequency specific to provide most, or all, of their light output at frequencies providing the highest rate of growth for the strain of algae being grown.

Additionally, it is desirable to provide agitation within the vessel to keep the algae circulating as they grow. Doing so aids in providing a uniform distribution of the algae throughout the nutrient-algae mixture. Agitation may be provided by one or more fan or propellor-type rotating devices, avoiding the use of expensive pumps.

As the algae grow, larger algae can “shade” smaller algae from the illumination, thus potentially retarding the growth of the smaller algae. It is therefor desirable to periodically filter larger algae from the nutrient-algae mixture, either by chemical or mechanical filtering. The filtering process draws the larger algae down into a lower zone from which the algae can be extracted. As algae and fluid are removed from the vessel, additional algae, water, and nutrients are added to the upper zone to continue the growing process.

This method allows the growth process to be continuous, so that the production of algae is not interrupted during the extraction phase. Additionally, multiple bioreactors of this design may feed grown algae into a centralized harvest and extraction system, minimizing loss of production should it be necessary to take a bioreactor off line for maintenance

Once extracted from the vessel, the algae are separated from the water by well-known techniques. The algae may then be processed to create a variety of products, including food products and biodiesel.

### BRIEF DESCRIPTION OF THE DRAWINGS

FIG. 1A is a schematic side view of one embodiment of the invention.

FIG. 1B is a schematic top view of one embodiment of the invention.

### DETAILED DESCRIPTION

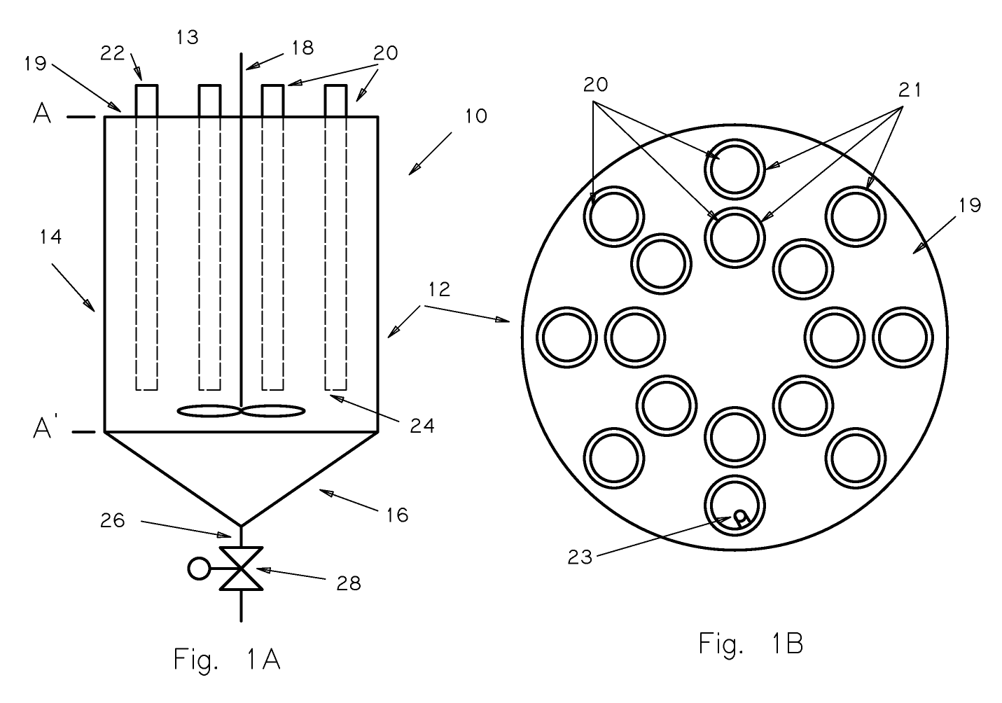

Referring to FIG. 1A, a schematic side view of an embodiment of the invention is shown. Bioreactor 10 comprises a vessel 12, into which is placed a mixture of nutrient, water, and algae. Vessell 12 comprises an upper zone 14, generally that portion of vessel 12 between mark lines A-A′, and a lower zone 16. Algae grow in the upper zone, and when of sufficient size are filtered into the lower zone 16 for harvesting.

An agitator 18 rotates to provide general mixing of the algae-nutrient fluid. Those of skill in the art will recognize that the size, shape, and rotational speed of agitator 18 are matters of engineering choice, and may vary depending on the strain of algae being grown.

Transparent tubes 20 each comprise an open end 22 and a sealed end 24, and extend into the algae-nutrient mixture (as depicted by dashed extension lines). Light fixtures (not shown), preferably comprising fluorescent tubes are inserted into transparent tubes 20 to provided general illumination throughout the upper zone 14 of vessel 12, providing the light needed by the algae for photosythesis. As reflected in the top view of FIG. 1B, transparent tubes 20 may be arrayed about the interior of vessel 12 in a manner to provided substantially uniform illumination within vessel 12.

Those of skill in the art will recognize that factors such as lighting duty cycles and the frequencies of the light used are matters of engineering choice, and optimizing such factors will likely vary depending on the strain of algae being grown.

Algae additionally require carbon dioxide to grow. Depending on engineering choice, it may be desirable to provide a means of injecting carbon dioxide into the algae-nutrient mixture to promote growth. Atmospheric carbon dioxide may provide a sufficient source for algae to grow. However, leaving the algae-nutrient fluid exposed to ambient air increases the risk of harmful contamination. Accordingly, it is preferred that vessel 12 comprise a lid 19, and that transparent tubes 20 pass relatively tightly through holes 21 in lid 19. Gaskets (not shown) may be provided to improve the sealing relationship between holes 21 and transparent tubes 20.

Those of skill in the art will recognize that various systems for injecting carbon dioxide into a fluid mixture are known, and that if one is desired, its construction will be a matter of engineering choice. Vessel 12 may thus optionally be provided with a selectively openable gas inlet 23 to allow for carbon dioxide injection. For example, selectively openable gas inlet 23 may pass through the side of one of the transparent tubes 20 below the level of lid 19, allowing carbon dioxide to be introduced into vessel 12. To prevent interference with the agitation of the fluid, the carbon dioxide feed is preferable directed toward the outside wall of vessel 12. However, a variety of other configurations may be used, such as providing a gas inlet through the wall of vessel 12.

When algae are of sufficient size, they are filtered out of the algae-nutrient mixture either by chemical or mechanical means, the techniques of which are known to those skilled in the art. These larger algae are filtered into the lower zone 16 of vessel 12, where they are removed from vessel 12 via outlet line 26 controlled by valve 28. As removal occurs, additional algae-nutrient-water mixture is added to the upper zone 14 of vessel 12, allowing bioreactor 10 to operate in a continuous-production mode.

After removal from bioreactor 10, algae are processed first by separating them from the water and any nutrient remaining therein, then by further processing as desired. The water and nutrient can be recycled for re-use in the bioreactor 10.

Those of skill in the art will recognize that the above descriptions are by way of example only, and are not considered to limit the scope of the invention as claimed.

I claim:

1. A method of producing algae in a controlled environment, comprising the steps of
providing a vessel holding a nutrient solution and algae,
providing a light source within said solution,
agitating said solution,
filtering sufficiently grown algae from said solution, and
removing said sufficiently grown algae from said vessel.

2. The method of claim 1, wherein the step of providing a light source within said solution additionally comprises the step of providing essentially uniform illumination throughout said solution.

3. The method of claim 1, wherein the step of filtering sufficiently grown algae from said solution additionally comprises the step of utilizing chemical filtering.

4. The method of claim 1, wherein the step of filtering sufficiently grown algae from said solution additionally comprises the step of utilizing mechanical filtering.

5. The method of claim 1, additionally comprising the step of providing a secondary source of carbon dioxide to said solution.

6. A bioreactor for growing algae in a controlled environment, comprising
a vessel comprising an upper zone and a lower zone,
a transparent enclosure positioned at least partially within said upper zone of said vessel, wherein the portion of said transparent enclosure within said upper zone is waterproof,
a light source positioned within said transparent enclosure,
an agitator positioned within said upper zone of said vessel, and
a selectively openable outlet in said lower zone of said vessel.

7. The bioreactor of claim 6, comprising a plurality of said combination of said transparent enclosures and said light sources.

8. The bioreactor of claim 7, wherein said transparent enclosures are positioned to provide essentially uniform illumination throughout said upper zone of said vessel.

9. The bioreactor of claim 6, additionally comprising a selectively openable gas inlet in said upper zone of said vessel.
